(19) United States
(12) Patent Application Publication
(10) Pub. No.: US 2008/0185843 A1
(43) Pub. Date: Aug. 7, 2008

(54) Device for the Liquid-Proof Connection of a Soft Tube

(76) Inventor: Marcel Roll, Maur (CH)

Correspondence Address: George Pappas;Pappas Law Offices, 919 S. Harrison Street, Suite 300, Fort Wayne, IN, 46802, US

(21) Appl. No.: 11/883,007

(22) PCT Filed: Jan. 28, 2005
(86) PCT No.: PCT/CH2005/000044

§ 371 Date: Jul. 25, 2007

(51) Int. Cl. F16L 19/10

(52) U.S. Cl. 285/382.2

(57) ABSTRACT

Disclosed is a device for the liquid-proof connection of a soft tube (2) to a connecting piece (4). Said device comprises a connecting piece (4) with a tube joint (6) for attaching the tube (2) as well as a clamping sleeve (8) which is provided with at least two sleeve segments (10) that are distributed along the circumference thereof, protrude from the tube joint (6), and are equipped with a stopping area (30) on the exterior face. A union nut (12) is also provided which cooperates with the stopping area (30) of the sleeve segments (10) by means of an interior stopping area (14) in order to press the same against the tube (2) such that a tight and removable connection is created.

This application claims priority of PCT application PCT/2005/000044 having a priority date of Jan. 28, 2005, the disclosure of which is incorporated herein by reference.

### TECHNICAL FIELD

The device for liquid-proof connection of a soft tube to a connecting piece.

### PRIOR ART

In the known connection devices a tube is slid on a connecting piece and attached by means of a tube clamp or bushing. In the first case, a sterile passage between the connecting piece and the tube cannot be guaranteed. In the second case, the connection is a not releasable.

### SUMMARY OF THE INVENTION

It is an object of the present invention to provide a connection device that allows a liquid-proof, sterile and releasable connection between a tube and a connecting piece.

The clamping sleeve that is pressed against a tube end applied on a connecting piece by means of a screwable union nut allows, on the one hand, a liquid-proof, sterile and releasable connection between the tube and the connection piece and, on the other hand, is releasable.

The tube stub can have a smooth surface at the exterior face thereof, but preferably it is roughened up or, it is provided with at least one retaining groove in order to improve the secure connection between the tube and the tube piece. Analogously, also the sleeve segment of the clamping sleeve can be smooth at its interior face, but preferably it is roughened up, and more preferably it is provided with at least one retaining groove on the interior face in order to improve a tight and durable connection.

The clamping sleeve can be arranged loosely on the tube stub and can be pressed against a stop. More advantageous is an embodiment, according to which the clamping sleeve is provided with a mounting ring comprising an inner thread that can be screwed onto an outer thread that is arranged at a step of the connecting piece which is attached to the tube stub via a step. In this case, it can be of further advantage if the mounting ring of the clamping sleeve is provided with an outer thread onto which the union nut can be screwed on by means of an inner thread. In the case of a loose clamping sleeve, the step of the connecting piece may directly protrude radially with its outer thread by as much that the union nut can be directly screwed onto this portion of the connecting piece by means of the inner thread.

The sloped stopping face of the clamping sleeve can be formed in various ways, it is advantageously formed as a portion of an exterior tapered segment. Analogously, also the sloped stopping face of the union nut can be formed in various ways, but another embodiment according to which the sloped stopping face is formed as a portion of an interior tapered segment, is favored.

The clamping sleeve can be made of metal, but preferably, it is made of plastic.

The connecting piece and/or the union nut can also be made of various materials, for example of plastic, but advantageously they are made of metal.

The connection device is useful for various kinds of soft tubes, which are preferably made of plastic. They can be reinforced, for example with tissue, wires or multilayers, or they may comprise a combination of all.

The connection device of the present invention is a high-quality, re-usable tube connection that satisfies the highest requirements of chemical, pharmaceutical and biochemical industry as well as of the food industry. Such a connection device can be produced in various dimensions and with various connecting pieces. The clamping sleeve allows compensating for different wall strengths of the tubes without affecting the pressure resistance.

### BRIEF DESCRIPTION OF THE DRAWINGS

Examples of the connection device will be described hereinbelow in more detail by means of the drawings, wherein:

FIG. 1 shows a connection device on a tube, in a side view, wherein the upper half is shown as a section;

FIG. 2 shows a connecting piece of the connection device, in a side view and as a section;

FIG. 3 shows a clamping sleeve of the connection device, in a side view and as a section; and

FIG. 4 shows a union nut of the connection device, in a side view and as a section.

### DETAILED DESCRIPTION OF THE INVENTION

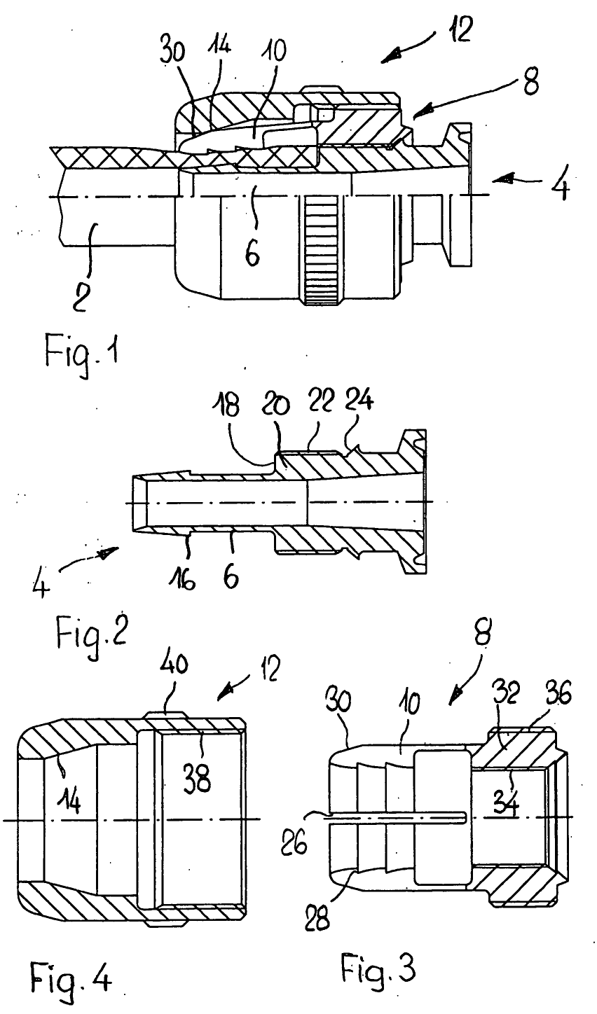

FIGS. 1 to 4 show a device for liquid-proof connection of a soft tube 2 to a connecting piece 4. The connecting piece 4 is provided with a tube stub 6 for attaching the tube 2. A clamping sleeve 8, which is provided with at least two or several sleeve segments 10 that are distributed along the circumference thereof, protrudes from the tube stub 6 together with said sleeve segments. A union nut 12 can be screwed together with the clamping sleeve 8 and is provided with interior sloped stopping faces 14 that cooperate with the sleeve segments 10 in order to press them against the tube 2. FIG. 2 shows the connecting piece 4 in detail. The tube stub 6 is provided with a retaining groove 16 and is formed with a transition over a step 18 to a portion 20 having an outer thread 22 and a stop 24.

FIG. 3 shows the clamping sleeve 8 in detail. The sleeves are provided, in the present case, with four sleeve segments 10 that are distributed along the circumference thereof and that are separated from each other by slits 26. These sleeve segments 10 are provided on the interior face thereof with several retaining grooves 28 that cooperate with tube 2, as shown in FIG. 1. The sleeve segments 10 are equipped with sloped stopping faces 30 on the exterior face that are substantially formed as a portion of an exterior tapered segment. The sleeve segments 10 are integrally formed on a mounting ring 32 that is provided with an inner thread 34 so that the mounting ring 32 can be screwed onto the outer thread 22 of the connecting piece 4 until the clamping sleeve 32 abuts against stop 24. The mounting ring 32 is further provided with an outer thread 36, to which the union nut 12 can be screwed on by means of an inner thread 38.

The union nut 12, shown in FIG. 4, further comprises a sloped stopping face 14 that cooperates with the sloped stopping face 30 of the sleeve segments 10 of the clamping sleeve 8. A knurl 40 on the exterior face of the union nut 12 improves the grip of the union nut for tightening by hand. Instead of the knurl or in addition thereto, the union nut can be provided with flat side faces for applying a wrench, preferably with a torque indicator. Thus, the urging pressure of the sleeve segments onto the tube can be adjusted to an appropriate value in order to ensure a good sealing and a secure hold, on the one hand, and to avoid overtightening and a concomitant damage of the connection parts, on the other hand.

### LIST OF REFERENCE NUMERALS

2 tube

4 connecting piece

6 tube stub

8 clamping sleeve

10 sleeve segment

12 union nut

14 sloped stopping face

16 retaining groove

18 step

20 portions

22 thread

24 stop

26 slit

28 retaining groove

30 sloped stopping face

32 mounting ring

34 inner thread

36 outer thread

38 inner thread

40 knurl

1. A device for liquid-proof connection of a soft tube to a connecting piece, wherein the connecting piece is provided with a tube stub for applying the tube, and with a clamping sleeve, which is provided with at least two sleeve segments that are distributed along the circumference thereof, protrude from the tube stub and are equipped with a sloped stopping face on the exterior face, and, moreover, with a union nut, which cooperates with the sloped stopping face of the sleeve segments by means of an interior sloped stopping face in order to press the same against the tube, characterized in that the tube stub is formed with a transition over a step to a portion having an outer thread and a stop, onto which the clamping sleeve provided with a mounting ring having an inner thread may be screwed on against the stop, the mounting ring of the clamping sleeve being provided with an outer thread onto which the union nut may be screwed on by means of an inner thread.

2. The device according to claim 1, characterized in that the tube stub is provided with at least one retaining groove on the exterior face.

3. The device according to claim 1, characterized in that the sleeve segments are provided with at least one retaining groove on the interior face.

4. The device according to claim 1, characterized in that the sloped stopping face of the clamping sleeve is formed as a portion of an exterior tapered segment.

5. The device according to claim 1, characterized in that the sloped stopping face of the union nut is formed as a portion of an interior tapered segment.

6. The device according to claim 1, characterized in that the clamping sleeve is made of metal.

7. The device according to claim 1, characterized in that the clamping sleeve is made of plastic.

8. The device according to claim 1, characterized in that the connecting piece and/or the union nut are made of plastic.

9. The device according to claim 1, characterized in that the connecting piece and/or the union nut are made of metal.

10. The device according to claim 2, characterized in that the sleeve segments are provided with at least one retaining groove on the interior face.

11. The device according to claim 2, characterized in that the sloped stopping face of the clamping sleeve is formed as a portion of an exterior tapered segment.

12. The device according to claim 3, characterized in that the sloped stopping face of the clamping sleeve is formed as a portion of an exterior tapered segment.

13. The device according to claim 2, characterized in that the sloped stopping face of the union nut is formed as a portion of an interior tapered segment.

14. The device according to claim 3, characterized in that the sloped stopping face of the union nut is formed as a portion of an interior tapered segment.

15. The device according to claim 4, characterized in that the sloped stopping face of the union nut is formed as a portion of an interior tapered segment.

16. The device according to claim 2, characterized in that the clamping sleeve is made of metal.

17. The device according to claim 2, characterized in that the clamping sleeve is made of plastic.

18. The device according to claim 2, characterized in that the connecting piece and/or the union nut are made of plastic.

19. The device according to claim 2, characterized in that the connecting piece and/or the union nut are made of metal.
